(19) United States
(12) Patent Application Publication
(10) Pub. No.: US 2015/0068837 A1
(43) Pub. Date: Mar. 12, 2015

(54) THIN PANEL FOR ABSORBING ACOUSTIC WAVES EMITTED BY A TURBOJET ENGINE OF AN AIRCRAFT NACELLE, AND NACELLE EQUIPPED WITH SUCH A PANEL

(71) Applicant: AIRCELLE, Gonfreville L'Orcher (FR)

(72) Inventors: Laurent MOREAU, Le Havre (FR); Vincent MARTIN, Rouen (FR)

(21) Appl. No.: 14/518,496

(22) Filed: Oct. 20, 2014

Related U.S. Application Data
(63) Continuation of application No. PCT/FR2013/050858, filed on Apr. 18, 2013.

(30) Foreign Application Priority Data
Apr. 20, 2012 (FR) 12/53633

(51) Int. Cl. F02C 7/24

(52) U.S. Cl. CPC F02C 7/24
USPC 181/290

(57) ABSTRACT

The present disclosure relates to a thin panel for absorbing sound waves emitted by a turbofan of an aircraft nacelle. The thin panel includes a plate capable of vibrating so as to convert the waves into evanescent waves.

### CROSS-REFERENCE TO RELATED APPLICATIONS

This application is a continuation of International Application No. PCT/FR2013/050858, filed on Apr. 18, 2013, which claims the benefit of FR 12/53633, filed on Apr. 20, 2012. The disclosures of the above applications are incorporated herein by reference.

### FIELD

The present disclosure relates to the field of acoustic absorption for the nacelles of turbojet engines of aircrafts.

### BACKGROUND

The statements in this section merely provide background information related to the present disclosure and may not constitute prior art.

The sound emissions caused by the turbojet engines of an airplane are particularly intense at takeoff, while the airplane is generally proximate to inhabited areas.

Numerous researches covering the manner to reduce the sound emissions caused by the turbojet engines of aircrafts have been carried out these later years.

These researches have led in particular to the setting up of acoustic absorbing panels in the nacelle surrounding the turbojet engine, in the most emissive sound areas.

Conventionally, these panels operate according to the principle of Helmholtz resonators, and comprise to this end a set of cavities sandwiched between a solid structuring skin on the one hand, and a perforated skin on the other hand.

The perforated skin is disposed in front of the noise emission area, so that the acoustic waves penetrate through these perforations inside the cavities and attenuate therein.

Conventionally, the cavities are defined by cells with a substantially hexagonal section, so that these acoustic absorbing panels are commonly called “honeycombs”.

Depending on the needs, we may consider one single layer of such panels, or several superimposed layers, separated therebetween by porous septums (or membranes).

The drawback of such panels in particular is that they exhibit a high thickness, which makes difficult their integration in nacelles with lines that are more and more thin.

And this difficulty is increased for the nacelles with high bypass ratio, in which the acoustic frequencies to be absorbed are lower, thus necessitating further thicker absorbing panels.

### SUMMARY

The present disclosure provides acoustic absorption means exhibiting lesser encumbrance, with a substantially comparable effectiveness.

In particular, the present disclosure provides a thin panel for absorbing acoustic waves emitted by a turbojet engine of an aircraft nacelle, and this thin panel includes at least one plate capable of vibrating so as to make said waves evanescent.

This evanescence, which refers to well-known notions of the theory of the vibro-acoustic coupling between a wall and a fluid in which waves propagate, allows an improved absorption of the energy of the acoustic waves by the plate which starts to vibrate.

In this way, we obtain noise reduction means which, while being very effective, are particularly slightly cumbersome.

According to other features, this thin panel comprises at least one structuring skin on which said plate is fixed, and studs being interposed between this skin and this plate. The structuring skin allows maintaining the desired profile for the plate, and the studs allow the vibratory movements of this plate.

The present disclosure also relates to a nacelle for an aircraft turbojet engine, comprising at least one thin panel in accordance with the foregoing.

According to other features of this nacelle:

said acoustic absorbing thin panel is fixed between acoustic absorbing sandwich panels, and this arrangement allows combining different acoustic absorption means within a same nacelle;

thin and sandwich acoustic absorbing panels are interleaved according to the axial direction of the nacelle;

thin and sandwich sound absorbing panels are interleaved according to the circumferential direction of the nacelle;

said nacelle comprises such acoustic absorbing thin panels in the areas selected in the group comprising: the air inlet, the cold air stream, the hot air stream.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a longitudinal sectional schematic view of a nacelle of the prior art, surrounding an aircraft turbojet engine;

FIGS. 2, 3, 4, 5, 6, 7 are schematic views similar to that of FIG. 1, of nacelles in accordance with the present disclosure;

FIG. 2a is a detail view of the nacelle of FIG. 2;

FIGS. 3a, 3b, 3c, 3d are detail views of four possible alternatives of the nacelle of FIG. 3;

FIG. 7a is a cross sectional view taken along the A-A line of the nacelle of FIG. 7; and

FIGS. 7b and 7c are cross sectional views taken along the B-B line of FIG. 7, of two forms of this nacelle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

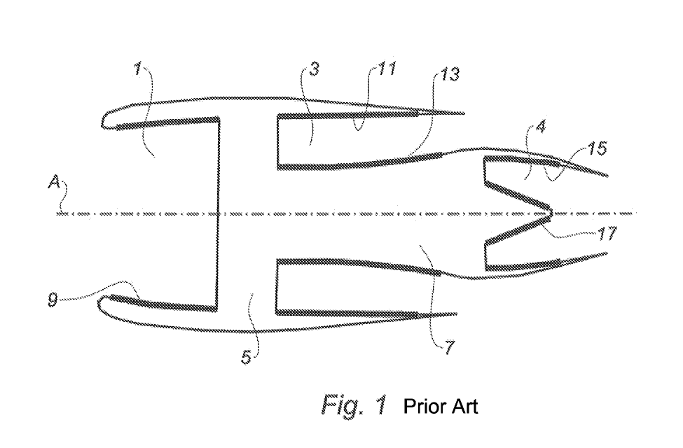

Referring now to FIG. 1, on which is represented a double flow conventional nacelle, defining an air inlet stream 1, a cold flow stream 3 and a hot flow stream 4.

Between the air inlet stream 1 and the cold flow stream 3 is located a fan 5, the turbojet engine 7 being in turn disposed between the fan 5 and the hot flow stream 4.

In operation, the air travels through the nacelle represented in FIG. 1 from the left to the right of the figure.

Very coarsely, this nacelle exhibits a rotational symmetry around its longitudinal axis A.

Conventionally, the air inlet stream 1 is surrounded by an acoustic absorbing shell 9, formed by the assembly of acoustic absorbing sandwich panels.

The cold flow stream 3 is in turn delimited by radially outer and inner walls equally coated at least partially with acoustic absorbing sandwich panels 11 and 13 respectively.

Finally, the hot flow stream 4 is delimited by a primary nozzle and a gas ejection cone, respectively and at least partially coated with acoustic absorbing sandwich panels 15, 17.

The locations of the acoustic absorbing sandwich panels 9, 11, 13, 15, 17 correspond to the zones of the nacelle with the strongest acoustic emissions.

The presence of these acoustic absorbing sandwich panels thus allows substantially diminishing the sound level perceived at the vicinity of the aircraft, in particular at takeoff or landing.

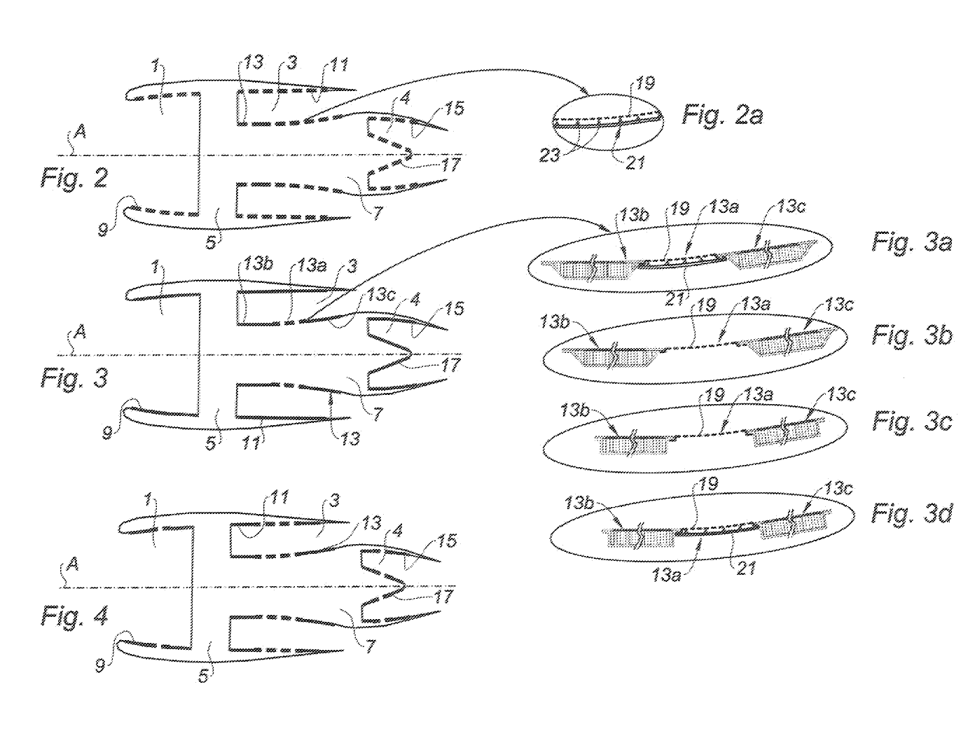

Referring now to FIG. 2a, on which we may see a nacelle according to the present disclosure, in which the acoustic absorbing sandwich panels 9, 11, 13, 15, 17 are all replaced by acoustic absorbing thin panels according to the present disclosure.

More precisely, as we may see in FIG. 2a, these thin panels comprise plates 19 and structuring skins 21, studs being interposed between these plates 19 and these skins 21.

The studs 23 fixed on the structuring skin 21 are in simple contact with the plate 19, thus authorizing the vibrations thereof.

At their periphery, the plates 19 and the skins 21 are fixed to each other.

The plate 19 may be formed for example in an aluminum-based alloy, and exhibit a thickness of about one millimeter.

The structuring skin 21 may in turn be formed either based on a metallic alloy, or based on a composite material, the same goes for the studs 23.

The characteristics of the plate 19 (thickness, elasticity modulus) are selected so as to make evanescent the acoustic waves circulating in the air streams delimited by these plates.

This evanescence notion is known per se, within the vibro-acoustic coupling between a wall and a fluid in which waves propagate. We might for example refer to the following articles:

“A finite element scheme for acoustic propagation in flexible-walled ducts with bulk-reacting liners and comparison with experiment” of ASTLEY, CUMMINGS and SORMAZ, Journal of Sound and Vibration (1991),

“Absorption d'une onde acoustique par les parois d'un guide 2D” of MARTIN and VIGNASSA, Journal de Physique IV, colloque C, supplement to Journal de Physique III, volume 2, April 1992,

“Wave propagation in a fluid filled rubber tube: theoretical and experimental results for Korteweg's wave” of GAUTIER, GILBERT, DALMONT and PICO VILA, of the Laboratory of Acoustics of the University of Maine, 2010.

Thanks to this evanescence phenomenon, an improved absorption of the energy of the acoustic waves by the vibrating plates 19 may be obtained.

This results in a significant attenuation of the noise emitted by the turbojet engine.

This attenuation is comparable to that obtained with acoustic absorbing sandwich panels, for a thickness encumbrance which is of course very lower.

In the following figure, the solid bold lines indicate conventional acoustic absorbing sandwich panels, and the broken bold lines indicate acoustic absorbing thin panels in accordance with the present disclosure.

Thus, in FIG. 3, we may see that the acoustic absorbing assembly 13, located on the radially inner wall of the cold flow stream 3, is formed of a thin panel 13a with a substantially annular shape, interleaved between two acoustic absorbing sandwich panels 13b and 13c.

As we may see in FIGS. 3a and 3d, this thin panel 13a may exhibit the structure indicated in FIG. 2a, fixed at its ends to acoustic panels exhibiting respectively beveled (FIG. 3a) or right (FIG. 3d) ends.

Alternatively, and as it is visible in FIGS. 3b and 3c, this thin panel 13a may be formed of one simple plate in metallic alloy 19, fixed at its ends on sandwich panels 13b, 13c exhibiting respectively beveled or right ends.

In the form represented in FIG. 4, we may see that the principle of axial alternation of acoustic absorbing thin panels has been generalized to all the acoustic absorbing assemblies 9, 11, 13, 15, 17 of the nacelle.

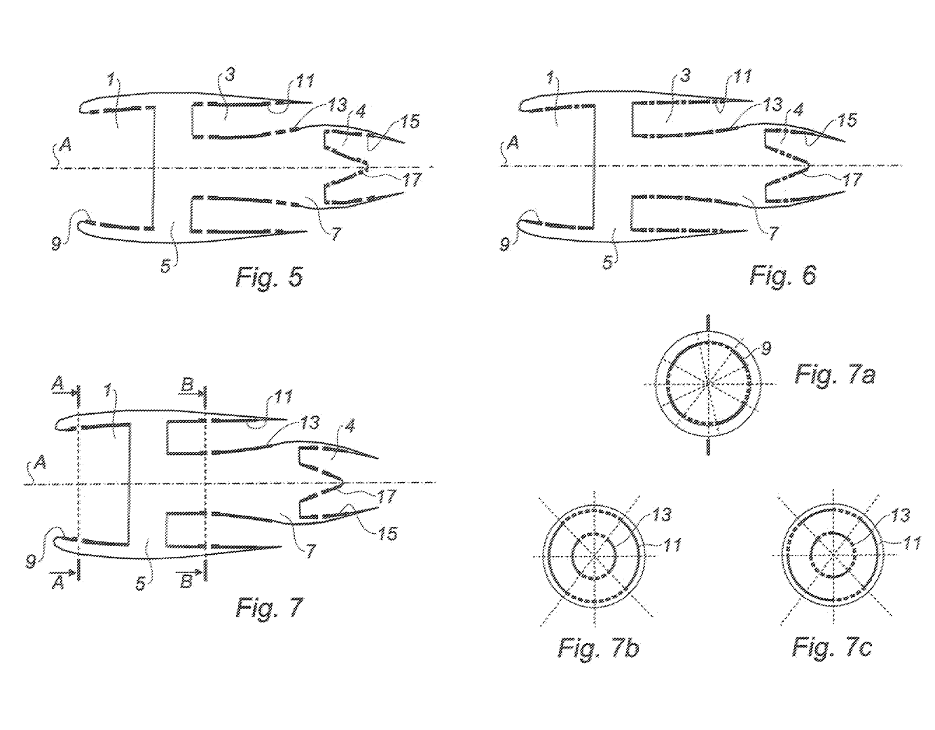

FIGS. 5 and 6 represent other forms of such axial alternations.

In particular, in FIG. 5, the alternation of thin panels and sandwich panels is reversed relative to that of FIG. 4.

In another form represented in FIG. 6, the sections of each thin and sandwich panel are axially smaller than in the other figures, so that the alternations of these panels are more numerous.

In the form represented in FIG. 7, the alternations of thin and sandwich panels are no longer axial, but circumferential.

Referring thus to FIG. 7a, we may see that we may have for example four thin panels interleaved with three sandwich panels to form the acoustic absorbing assembly 9 of at least one portion of the air inlet stream 1.

In FIGS. 7b and 7c, we may see that in the cold flow stream 3, we may expect that the thin and sandwich acoustic absorbing panels, circumferentially alternated and disposed respectively outside 11 and inside 13 the cold flow stream, are disposed facing each other (FIG. 7b) or opposite two by two (FIG. 7).

Of course, what has just been said about the cold flow stream 3 is also applicable to the hot flow stream 4.

As we may hence understand in light of the foregoing, the present disclosure provides noise reduction means which are very slightly radially cumbersome, and with an extremely simple design.

Hence, we may thus gain in place, weight and cost.

The acoustic absorbing thin panels of the present disclosure are particularly suitable to the nacelles with high bypass ratio, and more generally to nacelles that we seek to reduce the aerodynamic lines thickness thereof.

Of course, the present disclosure is by no means limited to the described and represented forms.

What is claimed is:

1. A thin panel for absorbing acoustic waves emitted by a turbojet engine of an aircraft nacelle, said thin panel comprising a plate configured to vibrate so as to make said waves evanescent.

2. The thin panel according to claim 1, further comprising at least one structuring skin on which said plate is fixed, and studs being interposed between said structuring skin and said plate.

3. A nacelle for an aircraft turbojet engine comprising at least one thin panel in accordance with claim 1.

4. The nacelle according to claim 3, wherein said at least one thin panel is fixed between acoustic absorbing sandwich panels.

5. The nacelle according to claim 4, wherein said thin panel is located on a radially inner wall of a cold air stream.

6. The nacelle according to claim 3, wherein said at least one thin panel and acoustic absorbing sandwich panels are interleaved according to an axial direction of the nacelle.

7. The nacelle according to claim 3, wherein said at least one thin panel and acoustic absorbing sandwich panels are interleaved according to a circumferential direction of the nacelle.

8. The nacelle according to claim 3, wherein said at least one thin panel is in an area selected from the group consisting of an air inlet, a cold air stream, and a hot air stream.

9. The nacelle according to claim 8, wherein at least four thin panels interleaved with acoustic absorbing sandwich panels to form an acoustic absorbing assembly of at least one portion of said air inlet stream.

10. The nacelle according to claim 8, wherein in said cold air stream, said thin panel and acoustic absorbing sandwich panels are circumferentially disposed outside and inside said cold air stream, respectively, and are disposed facing each other.
